(19) United States
(12) Patent Application Publication
(10) Pub. No.: US 2008/0246695 A1
(43) Pub. Date: Oct. 9, 2008

(54) Plasma display and driving method thereof

(76) Inventor: Dong-Myung Lee, Suwon-si (KR)

Correspondence Address: ROBERT E. BUSHNELL, 1522 K STREET NW, SUITE 300, WASHINGTON, DC, 20005-1202, US

(21) Appl. No.: 12/078,797

(22) Filed: Apr. 4, 2008

(30) Foreign Application Priority Data
Apr. 9, 2007 (KR) 10-2007-0034675

(51) Int. Cl. G09G 3/28

(52) U.S. Cl. 345/60

(57) ABSTRACT

In a plasma display and a driving method thereof, a sustain pulse of a high level voltage is supplied to a scan electrode or a sustain electrode during a sustain period using a capacitor charged to a voltage corresponding to a voltage difference between a high scan voltage and a low scan voltage. A low-voltage capacity transistor is connected between a power source and the scan electrode, the power source supplying a high level voltage to the scan electrode. Using the low-voltage capacity transistor results in reduced driving circuit costs and, in addition, the number of times that a transistor supplying the high scan voltage to the scan electrode and a transistor supplying the low scan voltage to the scan electrode is reduced, thereby reducing ElectroMagnetic Interference (EMI).

### CLAIM OF PRIORITY

This application makes reference to, incorporates the same herein, and claims all benefits accruing under 35 U.S.C. §119 from an application for PLASMA DISPLAY AND DRIVING METHOD THEREOF earlier filed in the Korean Intellectual Property Office on 9 Apr. 2007 and there duly assigned Serial No. 10-2007-0034675.

### BACKGROUND OF THE INVENTION

1. Field of the Invention

The present invention relates to a plasma display and a driving method thereof.

2. Description of the Related Art

A plasma display is a flat panel display that uses a plasma generated by a gas discharge to display characters or images. It includes a Plasma Display Panel (PDP) wherein tens to millions of discharge cells (hereinafter referred to as cells) are arranged in a matrix format, depending on its size.

Generally, in a plasma display, a field (e.g., 1 TV field) is divided into respectively weighted subfields, and each subfield includes a reset period, an address period, and a sustain period in a temporal manner.

The reset period is for initializing the status of each cell so as to facilitate an addressing operation on the cell, and the address period is for performing an addressing operation so as to select turned-on/turned-off cells (i.e., cells to be turned on/off). The sustain period is for causing a discharge for displaying an image on the addressed cells.

More particularly, since a high level voltage and a low level voltage are alternatively supplied to an electrode that experiences the sustain discharge during a sustain period, a voltage of a transistor for supplying the high level voltage and the low level voltage is required to correspond to a difference between the high level voltage and the low level voltage. Accordingly, the cost of a driving circuit is increased due to the high voltage requirements of the transistor. When a transistor having such high voltage characteristics is used, a switching operation and a conduction loss are increased so that the driving circuit may be damaged.

### SUMMARY OF THE INVENTION

The present invention has been made in an effort to provide a plasma display with an advantage of using a transistor needing only low voltage requirements, and a driving method thereof.

An exemplary plasma display is provided according to one embodiment of the present invention. The plasma display includes a scan electrode, a selection circuit, a capacitor, and a third transistor. The scan electrode is supplied with a sustain pulse during a sustain period, the sustain pulse alternating between a first voltage and a second voltage, the second voltage being less than the first voltage. The selection circuit includes a first transistor that supplies a high scan voltage to the scan electrode and a second transistor that supplies a low scan voltage to the scan electrode. A first end of the first transistor and a first end of the second transistor are connected to the scan electrode. The capacitor has a first end connected to a second end of the first transistor and a second end connected to a second end of the second transistor. The capacitor is charged to a third voltage. The third transistor has a first end connected to a first power source that supplies a fourth voltage and a second end connected to the second end of the capacitor, the fourth voltage equal to a voltage difference between the first voltage and the third voltage.

An exemplary method according to another embodiment of the present invention drives a plasma display including a scan electrode, a first transistor, and a second transistor. The scan electrode is supplied with a sustain pulse alternating between a first voltage and a second voltage, the second voltage being that is less than the first voltage. The first transistor has a first end connected to the scan electrode and supplies a high scan voltage to the scan electrode, and the second transistor has a first end connected to the scan electrode and supplies a low scan voltage to the scan electrode. The method includes: charging a third voltage to a capacitor having a first end connected to a second end of the first transistor and a second end connected to a second end of the second transistor; applying the first voltage to the scan electrode by turning on a third transistor connected between a first power source that supplies a fourth voltage and the second end of the capacitor and turning on the first transistor, the fourth voltage corresponding to a voltage difference between the first voltage and the third voltage; and supplying the second voltage to the scan electrode.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a plasma display according to an exemplary embodiment of the present invention.

FIG. 2 includes driving waveforms of the plasma display according to the exemplary embodiment of the present invention.

FIG. 3 is a circuit diagram of a driving circuit of a scan electrode driver according to a first exemplary embodiment of the present invention.

FIG. 4 includes driving waveforms of the driving timing of a sustain period of the driving waveforms of FIG. 2 according to the first exemplary embodiment of the present invention.

FIGS. 5 and 6 are circuit diagrams for explaining a process for generating a driving waveform of a sustain period of the driving waveforms of FIG. 2 according to the first exemplary embodiment of the present invention.

FIG. 7 is a circuit diagram of a driving circuit of a scan electrode driver according to a second exemplary embodiment of the present invention.

FIG. 8 includes driving waveforms of the sustain period of the driving waveforms of FIG. 2 according to the second exemplary embodiment of the present invention.

FIGS. 9 and 10 are circuit diagrams for explaining a process for generating a driving waveform of a sustain period of the driving waveforms of FIG. 2 according to the second exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. In addition, unless explicitly described to the contrary, the word “comprise” and variations such as “comprises” and “comprising” will be understood to imply the inclusion of stated elements but not the exclusion of any other elements.

Throughout this specification and the claims that follow, the wall charge refers to a charge that is formed on a wall (for example, a dielectric layer) of the discharge cell close to the electrodes to be stored in the electrode. Even though the wall charge is not actually in contact with the electrode, hereinafter, it may be described that the wall charge is formed, accumulated, or stacked on the electrode. Furthermore, the wall voltage refers to a potential difference generated on the wall of the discharge cell by the wall charge.

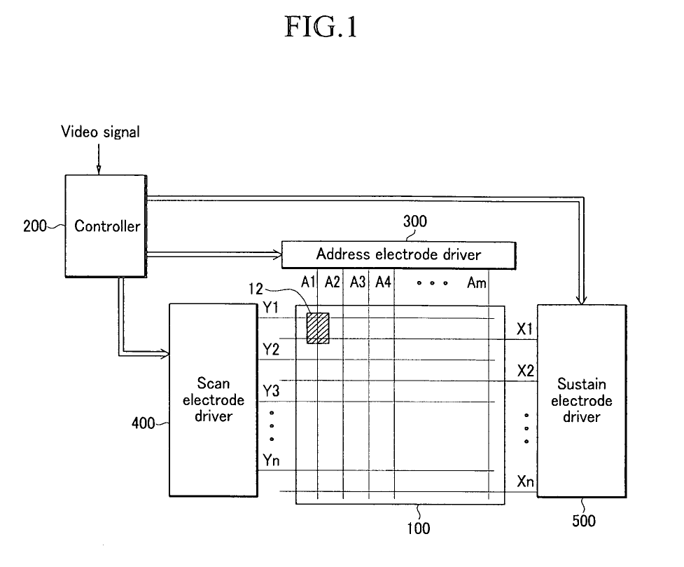

FIG. 1 is a block diagram of a plasma display according to an exemplary embodiment of the present invention.

As shown in FIG. 1, the plasma display includes a Plasma Display Panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain electrodes X1 to Xn and a plurality of scan electrodes Y1 to Yn extending in a row direction. The sustain electrodes X1 to Xn are formed in correspondence to the scan electrodes Y1 to Yn, and a display operation is performed by the sustain and scan electrodes X1 to Xn and Y1 to Yn in a sustain period. The scan and sustain electrodes Y1 to Yn and X1 to Xn are arranged perpendicular to the address electrodes A1 to Am. A discharge space formed at an area where the address electrodes A1 to Am cross the sustain and scan electrodes X1 to Xn and Y1 to Yn forms a discharge cell 12. This structure of the PDP 100 is merely exemplary, and panels having different structures to which the following driving waveforms can be supplied may be applied to the present invention.

The controller 200 receives external video signals and outputs an address electrode driving control signal, a sustain electrode driving control signal, and a scan electrode driving control signal. In addition, the controller 200 controls the plasma display by dividing a frame into a plurality of subfields. Each subfield includes a reset period, an address period, and a sustain period in a temporal manner.

The address electrode driver 300 receives the address electrode driving control signal from the controller 200, and supplies a display data signal for selecting discharge cells to be displayed to the respective address electrodes.

The scan electrode driver 500 receives the scan electrode driving control signal from the controller 200, and supplies a driving voltage to the scan electrode.

The sustain electrode driver 400 receives the sustain electrode driving control signal from the controller 200 and supplies a driving voltage to the sustain electrode.

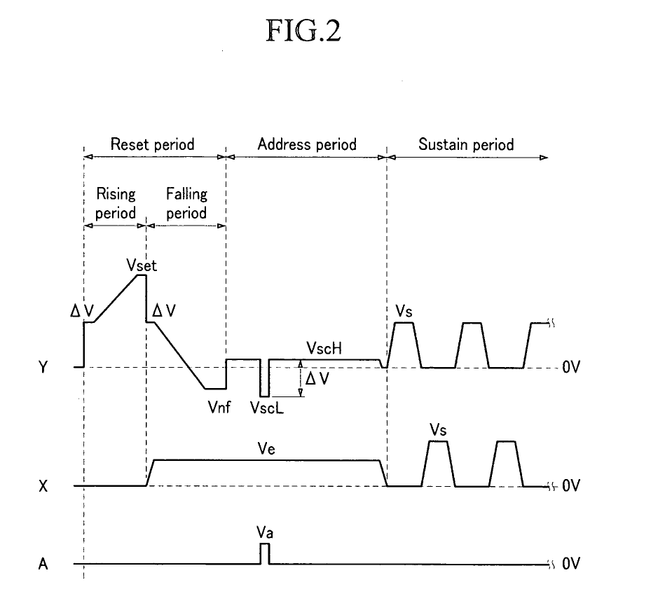

Hereinafter, a driving waveform supplied to the address electrodes A1 to Am, the sustain electrodes X1 to Xn, and the scan electrodes Y1 to Yn are described in further detail with reference to FIG. 2. For a better understanding and ease of description, a driving waveform supplied to an address electrode (hereinafter referred to as an A electrode), a sustain electrode (hereinafter referred to as an X electrode), and a scan electrode (hereinafter referred to as a Y electrode) forming one cell are described as follows.

FIG. 2 includes driving waveforms of the plasma display according to the exemplary embodiment of the present invention.

As shown in FIG. 2, during a rising period of the reset period, a voltage of the Y electrode is gradually increased from a ΔV voltage to a Vset voltage while maintaining a voltage of the X electrode and a voltage of the A electrode at a reference voltage (i.e., a ground voltage (0V) in FIG. 2). Herein, the ΔV voltage corresponds to a voltage difference between a VscH voltage and a VscL voltage. While the voltage of the Y electrode is increased, a weak discharge is generated between the Y and X electrodes and between the Y and A electrodes so that negative (−) wall charges are formed on the Y electrode and positive (+) wall charges are formed on the X and A electrodes.

During a falling period of the reset period, the voltage of the Y electrode is gradually decreased from the ΔV voltage to a Vnf voltage while maintaining the voltage of the A electrode and the voltage of the X electrode at the reference voltage and a Ve voltage, respectively. Then, a weak discharge is generated between the Y and X electrodes and between the Y and A electrodes while the voltage of the Y electrode is decreased so that the negative (−) wall charges formed on the Y electrode and the positive (+) wall charges formed on the X and A electrodes are erased. In general, a (Vnf-Ve) voltage is set close to a discharge firing voltage Vfxy between the Y electrode and the X electrode. Accordingly, a wall voltage between the Y electrode and the X electrode becomes close to the 0V voltage, and a misfire may be prevented from being generated during the sustain period in a cell in which no address discharge is generated during the address period.

During the address period, a scan pulse having a VscL voltage is sequentially supplied to the plurality of Y electrodes so as to select a cell to be turned on (i.e., turned-on cell) while the X electrode is supplied with the Ve voltage. A Va voltage is supplied to an A electrode that passes a discharge cell which is to emit light, selected from among a plurality of discharge cells formed by the Y electrode to which the VscL voltage is supplied and the X electrode. Accordingly, an address discharge is generated between the A electrode to which the Va voltage is supplied and the Y electrode to which the VscL voltage is supplied and between the Y electrode to which the VscL voltage is supplied and the X electrode to which the Ve voltage is supplied. Accordingly, positive (+) wall charges are formed on the Y electrode and negative (−) wall charges are formed on the A electrode and the X electrode. A Y electrode to which the VscL voltage is not supplied is supplied with a VscH voltage that is greater than the VscL voltage, and an A electrode of an unselected discharge is supplied with the reference voltage.

In order to perform the above-noted operation during the address period, the scan electrode driver 400 selects a Y electrode to which the scan pulse with the VscL voltage will be supplied from among the Y electrodes Y1 to Yn. For example, vertically arranged Y electrodes may be sequentially selected in a signal driving algorithm. When one of the Y electrodes Y1 to Yn is selected, the address electrode driver 300 selects turned-on discharge cells from among discharge cells formed by the selected Y electrode. That is, the address electrode driver 300 selects a discharge cell from among the A electrodes A1 to Am to which an address pulse having the Va voltage is supplied.

During the sustain period, a sustain pulse having a high level voltage (Vs voltage in FIG. 2) and a low level voltage (0V voltage in FIG. 2) is supplied to the Y electrode and the X electrode while having inverse phases. Then, the Vs voltage is supplied to the Y electrode and the 0V voltage is supplied to the X electrode so that a sustain discharge is generated between the Y electrode and the X electrode, and negative (−) wall charges are formed on the Y electrode and positive (+) wall charges are formed on the Y electrode and the X electrode by the sustain discharge. An operation for supplying the sustain pulse to the Y electrode and the X electrode is repeatedly performed a number of times corresponding to a weight value of the corresponding subfield. In general, the sustain pulse is a square waveform having a Vs sustain period.

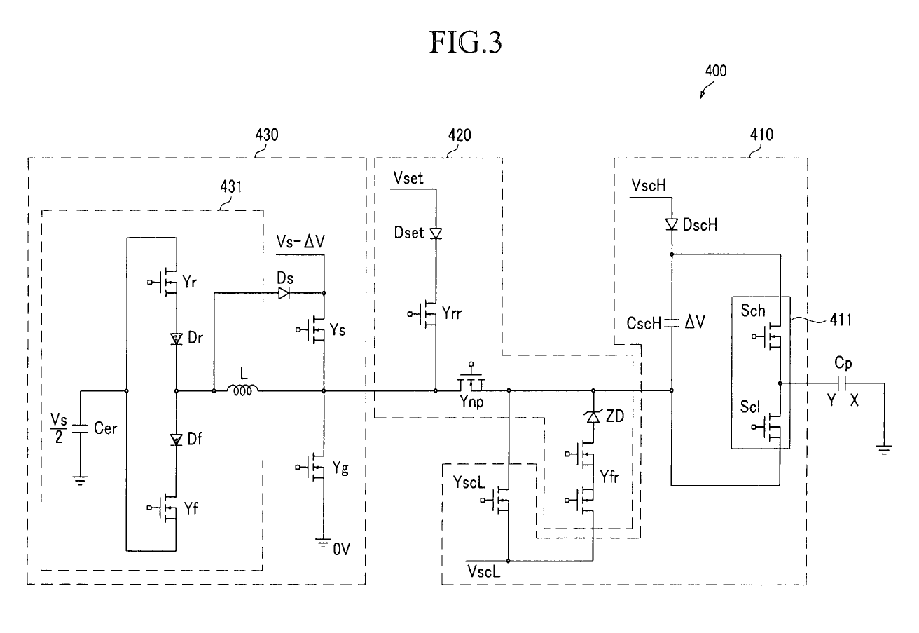

A driving circuit that generates a driving waveform selected from among the driving waveforms of FIG. 2 supplied to the scan electrode is described in further detail as follows with reference to FIG. 3. In FIG. 3, a plurality of transistors are illustrated as N-channel Metal Oxide Semiconductor Transistors (NMOSs), and each transistor has a body diode formed in a source to a drain direction thereof. Rather than using NMOS transistors, other transistors having the same functions as the NMOS transistors can be used. In addition, the transistors are respectively illustrated as single transistors in FIG. 3, and the respective transistors may be formed of a plurality of transistors coupled in parallel to each other. A capacitive component formed by the X electrode and the Y electrode is illustrated as a panel capacitor Cp.

FIG. 3 is a circuit diagram of a driving circuit of a scan electrode driver 400 according to a first exemplary embodiment of the present invention.

As shown in FIG. 3, the scan electrode driver 400 according to the first exemplary embodiment of the present invention includes a first scan driver 410, a first reset driver 420, and a first sustain driver 430.

The first scan driver 410 includes a first selection circuit 411, a capacitor CscH, and a transistor YscL, and supplies a voltage VscL (i.e., scan low voltage) to the Y electrode to select a turned-on discharge cell in an address period and supplies a voltage VscH (i.e., scan high voltage) to a Y electrode of a turned-off discharge cell. In general, the respective Y electrodes Y1 to Yn are connected to the first selection circuit 411 in an IC form so that the plurality of Y electrodes Y1 to Yn can be sequentially selected during the address period. However, FIG. 3 illustrates the first selection circuit 411 connected to one Y electrode for convenience of description. The first selection circuit 411 includes transistors Sch and Scl. A source of the transistor Sch and a drain of the transistor Scl are respectively connected to a Y electrode of the panel capacitor Cp. A source of the transistor Scl is connected to a first end of the capacitor CscH and a drain of the transistor Sch is connected to a second end of the capacitor CscH. A source of the transistor YscL is connected to a power source VscL, and a drain of the transistor YscL is connected to the source of the transistor Scl. The diode DscH has an anode connected to a power source VscH that supplies a voltage VscH and a cathode connected to the drain of the transistor Sch. When the transistor YscL is turned on, a voltage (VscH-VscL) charges the capacitor CscH. The voltage (VscH-VscL) stored in the capacitor CscH corresponds to a voltage ΔV supplied to the Y electrode during a reset period. Hereinafter, the voltage (VscH-VscL) stored to the capacitor CscH is referred to as the voltage ΔV.

The first reset driver 420 includes transistors Yrr, Yfr, and Ynp, a Zener diode ZD, and a diode Dset, and gradually increases a voltage of the Y electrode to a voltage Vset from the voltage ΔV during a rising period of the reset period and decreases the voltage of the Y electrode from the voltage ΔV to a voltage Vnf during a falling period of the reset period. The transistor Yrr is connected between a power source (Vset-ΔV) that supplies a voltage (Vset-ΔV) and the Y electrode, and the diode Dset is connected between a drain of the transistor Yrr and the power source (Vset-ΔV). The transistor Yrr supplies the voltage Vset to the Y electrode through the capacitor CscH, and the diode Dset is connected in an opposite direction of a body diode of the transistor Yrr so as to interrupt a current caused by the body diode of the transistor Yrr. In addition, the transistor Yfr is connected between the power source VscL that supplies a voltage VscL and the transistor Scl, and since the voltage Vnf is higher than the voltage VscL in the driving waveform of FIG. 2, a cathode of the Zener diode ZD is connected to the transistor Yfr. It is assumed that the voltage Vnf is a voltage that is higher by a breakdown voltage of the Zener diode ZD than the voltage VscL. Since the voltage Vnf is higher than the voltage VscL voltage, a current path is formed through the body diode of the transistor Yrr when the transistor YscL is turned on. Therefore, the transistor Yrr is formed in a back-to-back manner to interrupt the current path through the body diode of the transistor Yfr. The transistor Ynf is connected between the transistor Yg and the transistor Yfr, and prevents a current path from being formed from the transistor Yg to the transistor Yfr.

The first sustain driver 430 includes a first power recovery unit 431 and transistors Ys and Yg. The first power recovery unit 431 includes transistors Yr and Yf, an inductor L, diodes Dr and Df, and a power recovery capacitor Cer.

A transistor Ys is connected between a power source (Vs-ΔV) that supplies a voltage (Vs-ΔV) and the source of the transistor Scl, and the transistor Yg is connected between a power source 0V that supplies a 0V voltage and the source of the transistor Scl. According to the X exemplary embodiment of the present invention, the transistor Ys is used for supplying a voltage (Vs-ΔV) to the Y electrode and the transistor Yg is used for supplying the 0V voltage to the Y electrode. When the transistor Ys is turned on and the transistor Sch is turned on, the voltage (Vs-ΔV) is added to a voltage (ΔV) across the capacitor CscH so that the Y electrode is supplied with a voltage Vs.

A first end of the power recovery capacitor Cer is connected to a node of the transistors Ys and Yg, and the power recovery capacitor Cer is charged with a Vs/2 voltage. In addition, a first end of the inductor L is connected to the Y electrode and a second end of the inductor L is connected to a drain of the transistor Yr, and a drain of the transistor Yf is connected to the second end of the inductor L and a source of the transistor Yf is connected to the first end of the power recovery capacitor Cer.

The diode Dr is connected between the source of the transistor Yr and the inductor L, and the diode Df is connected between the drain of the transistor Yf and inductor L. If the transistor Yf has a body diode, the diode Dr forms a rising path for increasing the voltage of the Y electrode, and if the transistor Yf has a body diode, the diode Df forms a falling path for decreasing the voltage of the Y electrode. The diodes Dr and Df may be omitted if the transistors Yr and Yf do not have the body diodes. With the above-described connection, the first power recovery unit 431 inductor L increases the voltage of the Y electrode to the voltage Vs from the 0V voltage or decreases the voltage of the Y electrode from the voltage Vs to the 0V voltage by using a resonance between the inductor L and the panel capacitor Cp.

In the first power recovery unit 431, a connection order between the inductor L, the diode Df, and the transistor Yf can be changed, and a connection order between the inductor L, the diode Dr, and the transistor Yr can also be changed. For example, the inductor L may be connected between the node of the transistors Yr and Yf and the power recovery capacitor Cer. In addition, although the inductor L is connected to the node of the transistors Yr and Yf in FIG. 3, the inductor L may be connected to a rising path formed by the transistor Yr or a falling path formed by the transistor Yf, respectively.

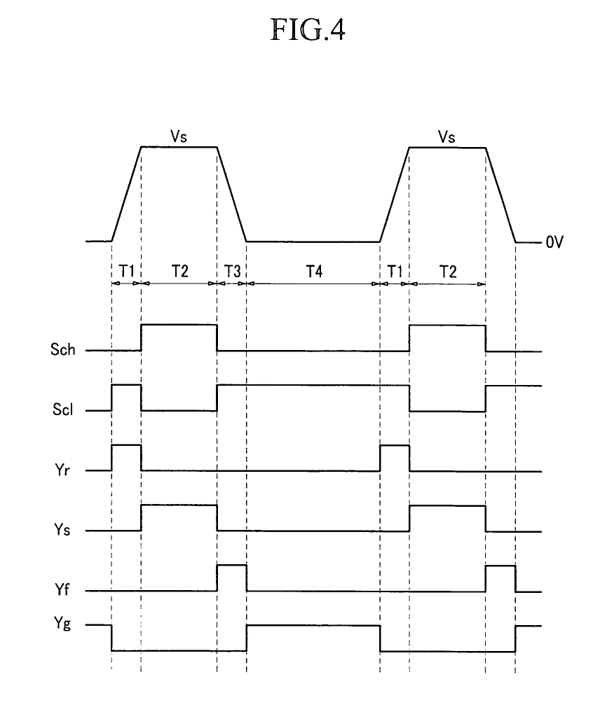

A method of generating a driving waveform supplied to the Y electrode during the sustain period of FIG. 2 is described below with reference to FIGS. 4 to 6.

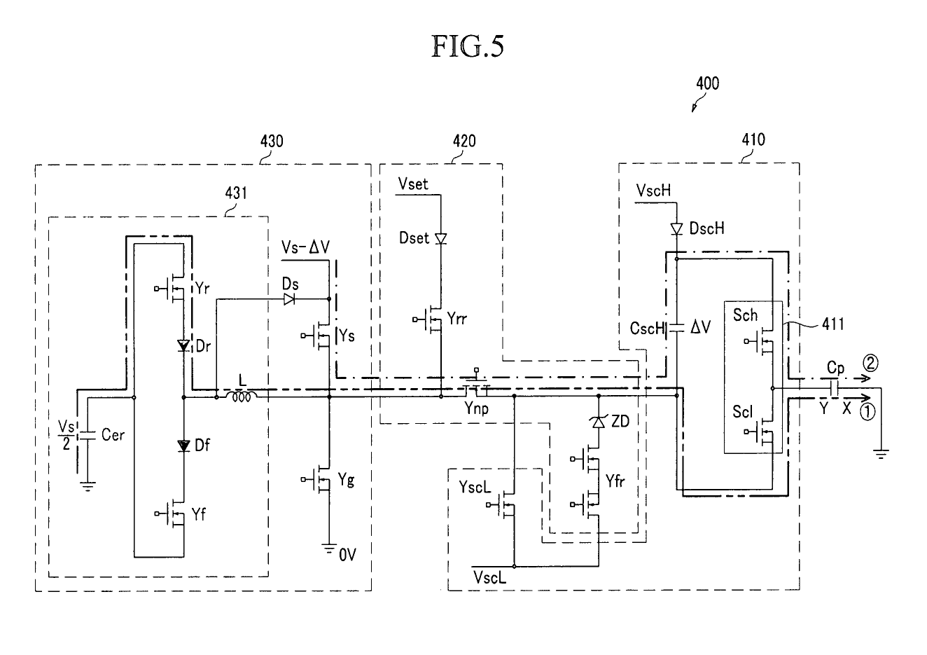

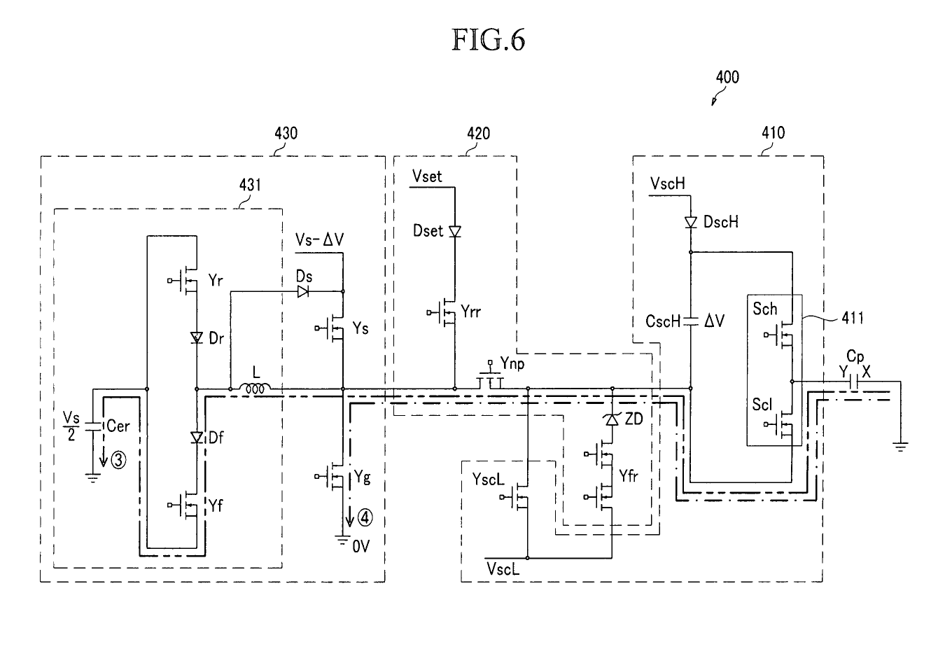

FIG. 4 includes driving waveforms of the driving timing of a sustain period of the driving waveforms of FIG. 2 according to the first exemplary embodiment of the present invention, and FIGS. 5 and 6 are circuit diagrams for explaining a process for generating a driving waveform of a sustain period of the driving waveforms of FIG. 2 according to the first exemplary embodiment of the present invention.

It is assumed that the transistor Yg is turned on before a period T1 of FIG. 4 and the Y electrode of the panel capacitor Cp is charged to the 0V voltage. In addition, it is assumed that the power recovery capacitor Cer is charged to the Vs/2 voltage.

In the period T1, the transistors Yr and Scl are turned on. When the transistors Yr and Scl are turned on, a current path (\textcircled{1}) is formed from the power recovery capacitor Cer through the transistor Yr, the diode Dr, the inductor L, the transistor Ynp, and the transistor Scl to the Y electrode of the panel capacitor Cp, as shown in FIG. 5. A resonance LC is generated through the path (\textcircled{1}) and the voltage of the Y electrode of the panel capacitor Cp is increased to close to the voltage Vs. Therefore, the current path (\textcircled{1}) is a rising path through which the voltage of the Y electrode is increased.

In a period T2, the transistors Yr and Scl are turned off and the transistors Ys and Sch are turned on. Then, a current path (\textcircled{2}) is formed from the power source (Vs-ΔV) through the transistor Ys, the capacitor CscH, and the transistor Sch to the Y electrode of the panel capacitor Cp, as shown in FIG. 5. Through the current path (\textcircled{2}), the voltage Vs is supplied to the Y electrode of the panel capacitor Cp. That is, the voltage (Vs-ΔV) supplied through the transistor Ys is added to the voltage ΔV across the capacitor CscH so that the voltage Vs is supplied to the Y electrode.

In a period T3, the transistors Ys and Sch are turned off and the transistors Yf and Scl are turned on. Then, a current path (\textcircled{3}) is formed from the Y electrode of the panel capacitor Cp through the transistor Scl, the inductor L, the diode Df, and the transistor Yf to the power recovery capacitor Cer, as shown in FIG. 6,

A resonance LC is generated through the current path (\textcircled{3}), and the voltage charged in the panel capacitor Cp is decreased to close to the 0V voltage. Therefore, the current path (\textcircled{3}) is a falling path through which the voltage of the Y electrode is decreased.

In a period T4, the transistor Yf is turned off and the transistor Yg is turned on. Then, a current path (\textcircled{4}) is formed from the Y electrode of the panel capacitor Cp through the transistor Scl and the transistor Yg to the power source 0V, as shown in FIG. 6. Through the current path (\textcircled{4}), the Y electrode of the panel capacitor Cp is supplied with the 0V voltage. By repeating the periods T1 to T4, a plurality of sustain pulses can be supplied to the Y electrode during the sustain period.

As described above, the Y electrode is supplied with the voltage Vs through the capacitor CscH charged to the voltage ΔV so that the voltage across the capacitor CscH becomes the voltage (Vs-ΔV) when the transistor Ys is turned off, according to the first exemplary embodiment of the present invention. Therefore, the transistor Ys may be provided as a low-capacity transistor using a low voltage and a low current, and accordingly, a driving circuit cost can be reduced.

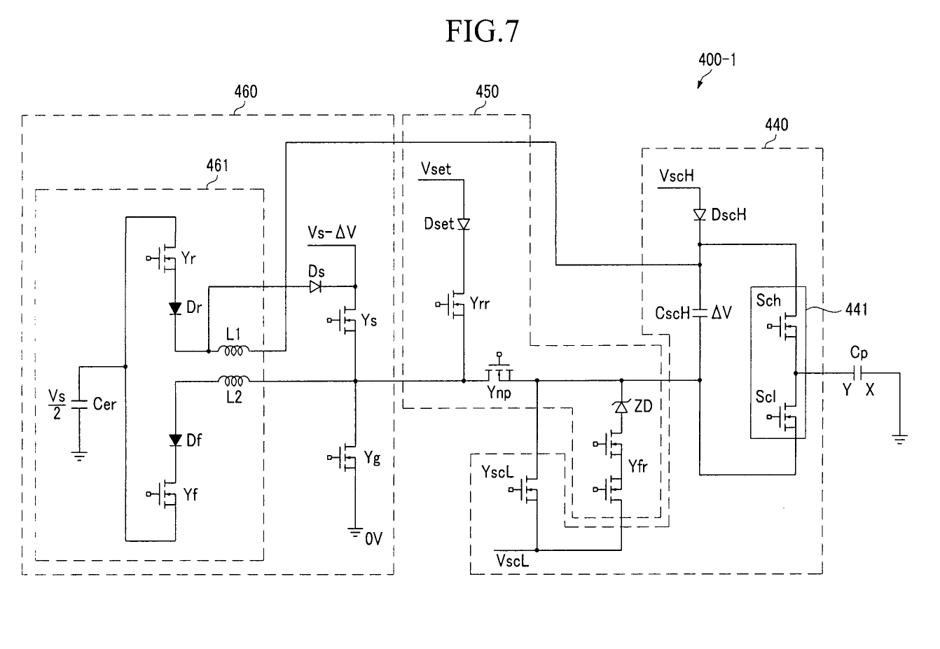

However, the transistors Sch and Scl included in the first selection circuit 411 are switched three times in a row for the periods T1 to T4 during which the sustain pulse is supplied. When the transistors Sch and Scl are switched in this manner, ElectroMagnetic Interference (EMI) increases. A driving circuit for reducing the EMI according to a second exemplary embodiment of the present invention is described in further detail below with reference to FIGS. 7 to 10, and a method of generating a driving waveform by using the driving circuit is also described.

FIG. 7 is a circuit diagram of a driving circuit of a scan electrode driver according to a second exemplary embodiment of the present invention.

As shown in FIG. 7, the scan electrode driver 400-1 according to the second exemplary embodiment of the present invention includes a second scan driver 440, a second reset driver 450, and a second sustain driver 460.

The second scan driver 440 is similar to the first scan driver 410, and the second reset driver 450 is similar to the first reset driver 420. In addition, the second sustain driver 460 is similar to the first sustain driver 430 of the first exemplary embodiment, except for using two inductors L1 and L2 in a second power recovery unit 461 rather than using one inductor L as in the first power recovery unit 431.

That is, the second sustain driver 460 is similar to the first sustain driver 430 except that a first inductor L1 and a second inductor L2 are respectively formed on a rising path formed by a transistor Yr and a falling path formed by a transistor Yf. The first inductor L1 is connected between a node of a transistor Sch and a power source VscH and a transistor Yr, and is used for forming a rising path through which the voltage of the Y electrode is increased. The second inductor L2 is connected between the transistor Yf and the transistor Scl, and is used for forming a falling path through which the voltage of the Y electrode is decreased.

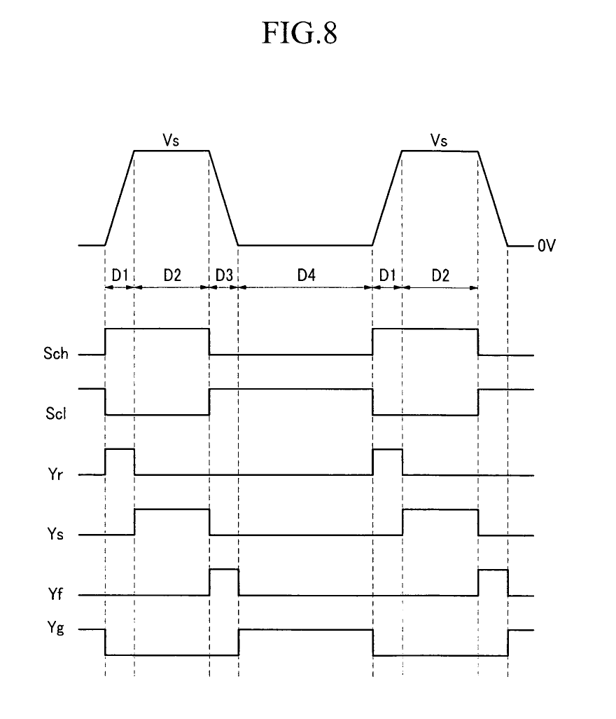

A method of generating a driving waveform supplied to the Y electrode during the sustain period among the driving waveform of FIG. 2 is described in further detail below with reference to FIGS. 8 to 10.

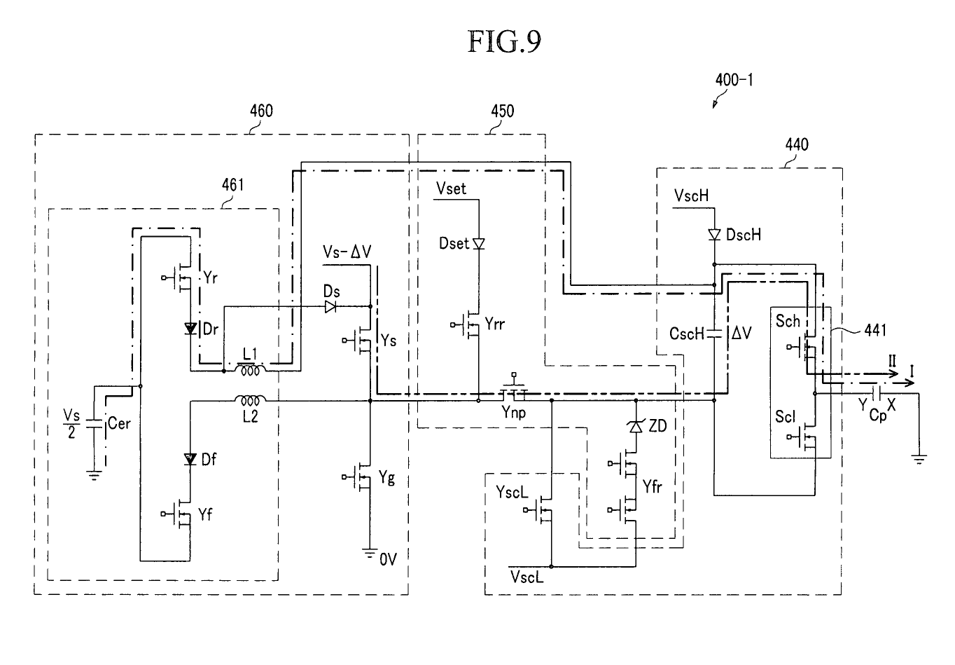

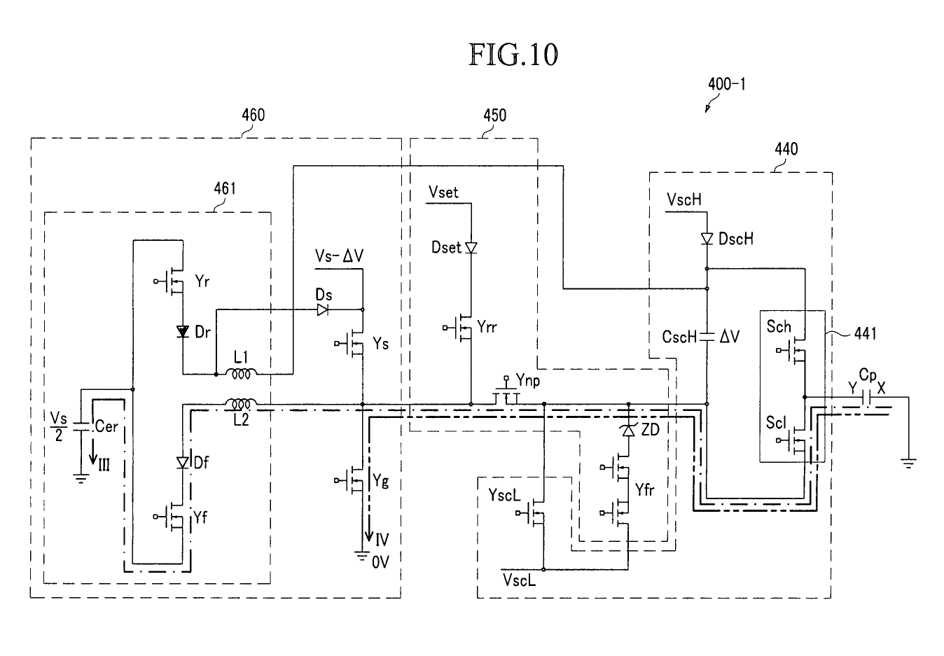

FIG. 8 includes driving waveforms of the sustain period of the driving waveforms of FIG. 2 according to the second exemplary embodiment of the present invention, and FIGS. 9 and 10 are circuit diagrams for explaining a process for generating a driving waveform of a sustain period of the driving waveforms of FIG. 2 according to the second exemplary embodiment of the present invention.

It is assumed that a transistor Yg is turned on before a period D1 of FIG. 8 so that a Y electrode of a panel capacitor Cp is maintained at a 0V voltage. In addition, it is assumed that a Vs/2 voltage is stored in a power recovery capacitor Cer.

In the period D1, the transistors Yr and Sch are turned on. Then, a current path (I) is formed from the power recovery capacitor Cer through the transistor Yr, a diode Dr, the first inductor L1, and the transistor Sch to the panel capacitor Cp, as shown in FIG. 9. A resonance LC is generated by the current path (I) so that a voltage of the Y electrode of the panel capacitor Cp is increased to close to the voltage Vs. Therefore, the current path (I) can be referred to as a rising path through which the voltage of the Y electrode is increased.

In a period D2, the transistor Yr is turned off and a transistor Ys is turned on. Then, a current path (II) is formed from a power source (Vs-ΔV) through the transistor Ys, a capacitor CscH, and the transistor Sch to the Y electrode of the panel capacitor Cp, as shown in FIG. 9. Through the current path (II), a voltage Vs is supplied to the Y electrode of the panel capacitor Cp. That is, a voltage (Vs-ΔV) supplied through the transistor Ys is added to a voltage ΔV across the capacitor CscH so that the voltage Vs is supplied to the Y electrode.

In a period D3, transistors Ys and Sch are turned off and the transistors Yf and Scl are turned on. Then, a current path (III) is formed from the Y electrode of the panel capacitor Cp through the transistor Scl, the second inductor L2, the diode Df, and the transistor Yf to the power recovery capacitor Cer, as shown in FIG. 10. A resonance is generated by the current path (III) so that the voltage stored in the panel capacitor Cp is decreased to close to the 0V voltage. Therefore, the current path (III) can be referred to as a falling path through which the voltage of the Y electrode is decreased.

In a period D4, the transistor Yf is turned off and the transistor Yg is turned on. Then, a current path (IV) is formed from the Y electrode of the panel capacitor Cp through the transistor Scl and the transistor Yg to a power source 0V, as shown in FIG. 10

Through the current path (IV), the Y electrode of the panel capacitor Cp is supplied with the 0V voltage.

As described, the transistors Sch and Scl included in the second selection circuit 441 are switched twice for the periods D1 to D4 during which the sustain pulse is supplied according to the second exemplary embodiment of the present invention. Therefore, the EMI can be reduced since the number of times of switching of the transistors Sch and Scl is reduced compared to the first exemplary embodiment of the present invention.

As described above, a capacitor that is charged to a voltage that corresponds to a voltage difference between a scan high voltage and a scan low voltage is used for supplying a high level voltage to a scan electrode during a sustain period, and therefore, a low-voltage capacity transistor can be used as a transistor to supply the high level voltage. Since a low-voltage capacity transistor is used, a driving circuit cost can be reduced. In addition, since the number of times a transistor included in a selection circuit is switched is reduced, EMI can be reduced.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A plasma display comprising:
a scan electrode supplied with a sustain pulse during a sustain period, the sustain pulse alternating between a first voltage and a second voltage, the second voltage being less than the first voltage;
a selection circuit including a first transistor to supply a high scan voltage to the scan electrode and a second transistor to supply a low scan voltage to the scan electrode, a first terminal of the first transistor and a first terminal of the second transistor being connected to the scan electrode;
a capacitor having a first end connected to a second end of the first transistor and having a second end connected to a second end of the second transistor, the capacitor being charged to a third voltage; and
a third transistor having a first end connected to a first power source supplying a fourth voltage and having a second end connected to the second end of the capacitor, the fourth voltage being equal to a voltage difference between the first voltage and the third voltage.

2. The plasma display of claim 1, further comprising a fourth transistor having a first end connected to a node between the second end of the third transistor and the second end of the second transistor, the fourth transistor supplying the second voltage to the scan electrode.

3. The plasma display of claim 1, wherein the first voltage is supplied to the scan electrode in response to the first and second transistors being turned.

4. The plasma display of claim 1, further comprising:
an inductor having a first end connected to a node between the second end of the second transistor and the second end of the capacitor;
a power recovery capacitor charged to a fifth voltage between the first voltage and the second voltage;
a rising path arranged between the power recovery capacitor and a second end of the inductor, the rising path increasing a voltage of the scan electrode; and
a falling path arranged between the power recovery capacitor and the second end of the inductor, the falling path decreasing the voltage of the scan electrode.

5. The plasma display of claim 4, wherein:
the rising path includes a fifth transistor and a first diode, the fifth transistor having a first end connected to the second end of the inductor and having a second end connected to the power recovery capacitor and the first diode having an anode connected to the first end of the fifth transistor and having a cathode connected to the second end of the inductor; and
the falling path includes a sixth transistor and a second diode, the sixth transistor having a first end connected to the second end of the inductor and having a second end connected to the power recovery capacitor and the second diode having a cathode connected to the first end of the sixth transistor and having an anode connected to the second end of the inductor.

6. The plasma display of claim 5, wherein, in response to the first and fifth transistors being turned on, a current path is formed from the power recovery capacitor through the fifth transistor, the first diode, and the first transistor to the scan electrode, and wherein the voltage of the scan electrode is increased from the second voltage to the first voltage through the current path.

7. The plasma display of claim 5, wherein, in response to the second and sixth transistors being turned on, a current path is formed from the scan electrode through the second transistor, the inductor, the second diode, and the sixth transistor to the power recovery capacitor, and wherein the voltage of the scan electrode is decreased from the first voltage to the second voltage through the current path.

8. The plasma display of claim 1, comprising:
a first inductor having a first end connected to a node between the second end of the first transistor and the second end of the capacitor;
a second inductor having a first end connected to a node between the second end of the second transistor and the first end of the capacitor;
a power recovery capacitor charged to a fifth voltage between the first voltage and the second voltage;
a rising path arranged between the power recovery capacitor and the second end of the inductor, the rising path increasing a voltage of the scan electrode; and
a falling period arranged between the power recovery capacitor and a second end of the second inductor, the falling path decreasing the voltage of the scan electrode.

9. The plasma display of claim 8, wherein:
the rising path includes a fifth transistor and a first diode, the first transistor having a first end connected to the second end of the inductor and having a second end connected to the power recovery capacitor and the first diode having an anode connected to the first end of the fifth transistor and having a cathode connected to the second end of the first inductor; and
the falling path includes a sixth transistor and a second diode, the sixth transistor having a first end connected to the second end of the inductor and having a second end connected to the power recovery capacitor and the second diode having a cathode connected to the first end of the sixth transistor and having an anode connected to the second end of the second inductor.

10. The plasma display of claim 9, wherein, in response to the first and fifth transistors being turned on, a current path is formed from the power recovery capacitor through the fifth transistor, the first diode, the inductor, and the first transistor to the scan electrode, and wherein the voltage of the scan electrode is increased from the second voltage to the first voltage through the current path.

11. The plasma display of claim 9, wherein, in response to the second and sixth transistors being turned on, a current path is formed from the scan electrode through the second transistor, the inductor, the second diode, and the sixth transistor to the power recovery capacitor, and wherein the voltage of the scan electrode is decreased from the first voltage to the second voltage through the current path.

12. A method of driving a plasma display device including a scan electrode, a first transistor, and a second transistor, the scan electrode applied with a sustain pulse alternately having a first voltage and a second voltage that is less than the first voltage, the first transistor having a first end connected to the scan electrode and applying a scan high voltage to the scan electrode, and the second transistor having a first end connected to the scan electrode and applying a scan low voltage to the scan electrode, the method comprising:
charging a third voltage to a capacitor having a first end connected to a second end of the first transistor and a second end connected to a second end of the second transistor;
applying the first voltage to the scan electrode by turning on a third transistor connected between a first power source that supplies a fourth voltage and the second end of the capacitor and turning on the first transistor, the fourth voltage corresponding to a voltage difference between the first voltage and the third voltage; and
applying the second voltage to the scan electrode.

13. The method of claim 12, wherein the supplying the first voltage to the scan electrode comprises forming a current path from the first power source through the third transistor, the capacitor, and the first transistor to the scan electrode in response to turning on the first and third transistors.

14. The method of claim 12, further comprising connecting a first end of an inductor to a node between the second end of the capacitor and the second end of the second transistor, and increasing a voltage of the scan electrode from the second voltage to the first voltage by forming a current path from the inductor through the second transistor to the scan electrode.

15. The method of claim 14, further comprising decreasing the voltage of the scan electrode by forming a current path from the scan electrode through the second transistor to the inductor.

16. The method of claim 12, further comprising:
connecting a first end of a first inductor to a node between the second end of the first transistor and the first end of the capacitor and connecting a first end of a second inductor to a node between the second end of the second transistor and the second end of the capacitor:
increasing a voltage of the scan electrode from the second voltage to the first voltage by forming a current path from the first inductor through the first transistor to the scan electrode; and
decreasing the voltage of the scan electrode from the second voltage to the first voltage by forming a current path from the scan electrode through the second transistor to the second inductor.
